(19) United States
(12) Patent Application Publication
(10) Pub. No.: US 2021/0374442 A1
(43) Pub. Date: Dec. 2, 2021

(54) DRIVING AID SYSTEM

(71) Applicant: GENTEX CORPORATION, Zeeland, MI (US)

(72) Inventors: Thomas S. Wright, Holland, MI (US); Eric P. Bigoness, Ada, MI (US); Phillip R. Pierce, Grand Rapids, MI (US); Bradley A. Bosma, Hudsonville, MI (US)

(73) Assignee: GENTEX CORPORATION, Zeeland, MI (US)

(21) Appl. No.: 17/330,784

(22) Filed: May 26, 2021

Related U.S. Application Data
(60) Provisional application No. 63/029,753, filed on May 26, 2020.

(51) Int. Cl. G06K 9/00; B60R 1/12; B60R 11/02; B60R 11/04; G10L 15/22

(52) U.S. Cl. CPC G06K 9/00818; B60R 1/12; B60R 11/0247; B60R 11/04; G10L 2015/225; B60R 2001/1215; B60R 2300/8066; G10L 2015/223; G10L 15/22

(57) ABSTRACT

Systems for aiding a vehicle driver are disclosed. A system may comprise an imager having a field of view forward relative a vehicle and operable to capture a first image. The system may further comprise a controller communicatively connected to the imager. The controller may be operable to detect a road sign in the first image, to interpret the road sign, and to provide an graphic representation of the road sign and/or provide an auditory response based, at least in part on the road sign. The graphic representation may be displayed by a rear-view assembly. The auditory response may be emitted by a speaker. In some embodiments, a location may be associated with one or more road sign interpretation and both the location and interpretation may be transmitted to a remote server.

### CROSS-REFERENCE TO RELATED APPLICATIONS

This application claims priority under 35 U.S.C. § 119(e) to U.S. Provisional Application No. 63/029,753 filed on May 26, 2020, entitled “DRIVING AID SYSTEM,” the disclosure of which is hereby incorporated by reference in its entirety.

### FIELD OF INVENTION

The present invention relates in general to driving aid systems and, more particularly, to driving aid systems related to road signs.

### BACKGROUND OF INVENTION

Distractions vying for a driver's attention are at an all-time high. As a result, drivers may have increased difficulty reading road signs as they drive. This difficulty may be further increased when driving faster, when navigating heavy traffic, or when there are field of view obstructions. Accordingly, systems for aiding drivers navigating roadways have become increasingly common for vehicles. However, these systems are often directed to collision avoidance and to directing the driver along a pre-determined route. Therefore, despite these systems, drivers may still have difficultly reading road signs. Accordingly, there is a need for improved driving aid systems.

### SUMMARY

In accordance with the present disclosure, the problems associated with reading road signs have been substantially reduced or eliminated.

According to one aspect of the present disclosure, a system is disclosed. The system may comprise a first imager, a controller, and/or a rearview assembly. The first imager may be operable to capture a first image. Further, the first imager may have a field of view forward relative a vehicle. The controller may be communicatively connected to the first imager. Additionally, the controller may be operable to: detect a road sign in the first image, interpret the road sign, and provide a graphic representation based, at least in part, on the road sign. The rearview assembly may be communicatively connected to the controller. Further, the rearview assembly may be operable to receive and display the graphic representation.

In some embodiments, the system may further comprise a second imager. The second imager may be operable to capture a second image. Further, the second imager may have a field of view rearward relative the vehicle. In such an embodiment, the rearview assembly may be operable to display the second image. In some such embodiments, the graphic representation may be overlaid onto the second image.

In some embodiments, the system may further comprise a microphone. The microphone may be communicatively connected to the controller and disposed interior the vehicle. Accordingly, the microphone may be operable to capture a driver's voice. In such an embodiment, the controller may be further operable to: interpret the driver's voice to identify at least one of a command and question, and communicate the graphic representation to the rearview assembly based, at least in part, on the at least one of the command and question.

In some embodiments, the system may further comprise a speaker. The speaker may be disposed interior the vehicle and communicatively connected to the controller. Further, the speaker may be operable to emit an auditory response. In such an embodiment, the controller may be further operable to: provide the auditory response based, at least in part, on the interpretation of the road sign, and communicate the auditory response to the speaker.

In some embodiments, the system may further comprise the microphone and the speaker. In such an embodiment, wherein the controller may be further operable to: interpret the driver's voice to identify at least one of a command and question, provide the auditory response based, at least in part, on the interpretation of the driver's voice, an communicate the auditory response to the speaker.

In some embodiments, the system may further comprise a location device. The location device may be operable to determine a location of the vehicle. Additionally, the location device communicatively connected to the controller. In some such embodiments, the controller may be further operable to associate the location at the time of capturing the first image with the road sign interpretation.

In some embodiments, the controller may be further operable to determine whether the road sign is likely of interest to a driver. Additionally, the controller may be further operable to selectively provide the graphic representation or selectively display the graphic representation based, at least in part, on a determination that the road sign is likely of interest to the driver.

According to another aspect of the present disclosure, a system is disclosed. The system may comprise a first imager, a controller, and/or a speaker. The first imager may be operable to capture a first image. Further, the first imager may have a field of view forward relative a vehicle. The controller may be communicatively connected to the first imager. Additionally, the controller may be operable to: detect a road sign in the first image, interpret the road sign, and provide an auditory response based, at least in part, on the road sign. The speaker may be disposed interior the vehicle and communicatively connected to the controller. Further, the speaker may be operable to emit the auditory response. In some embodiments, the controller may be further operable to: determine whether the road sign is likely of interest to a driver, and selectively provide the auditory response or selectively emit the auditory response based, at least in part, on a determination that the road sign is likely of interest to the driver.

In some embodiments, the system may further comprise a microphone. The microphone may be communicatively connected to the controller and disposed interior the vehicle. Accordingly, the microphone may be operable to capture a driver's voice. In some such embodiments, the controller may be further operable to: interpret the driver's voice to identify a command or a question, provide the auditory response based, at least in part, on the interpretation of the driver's voice, and communicate the auditory response to the speaker.

In some embodiments, the system may further comprise a display element. The display element may be communicatively connected to the controller. Additionally, the display element may be operable to receive and display a graphic representation. In such an embodiment, the controller may be further operable to provide the graphic representation based, at least in part, on the road sign.

In some embodiments, the system may further comprise a second imager. The second imager may be operable to capture a second image. Further, the second imager may have a field of view rearward relative the vehicle. Additionally, in some such embodiments, the display element may be further operable to display the second image.

In some embodiments, the system may further comprise a location device. The location device may be operable to determine a location of the vehicle. Additionally, the location device may be communicatively connected to the controller. In such an embodiment, the controller may be further operable to associate the location at the time of capturing the first image with the road sign interpretation.

According to yet another aspect of the present disclosure, a network is disclosed. The network may further disclose a plurality of systems. Each system may comprise an imager a location device, and/or a controller. The imager may be operable to capture a plurality of images. Additionally, the imager may have a field of view forward relative a vehicle. The location device may be operable to determine a location of the vehicle. The controller may be communicatively connected to the imager and the location device. Additionally, the controller, for each image of the plurality of images, may be operable to: detect a road sign in an image, interpret the road sign, and associate the location at the time of imaging the road sign with the road sign interpretation; and The server, relative each system, may be located remote relative the vehicle, communicatively connected to the controller, and operable to receive one or more road sign interpretations and associated locations. In some embodiments, the controller is further operable to determine whether the road sign is likely of interest to a driver, and selectively provide the graphic representation or selectively display the graphic representation based, at least in part, on a determination that the road sign is likely of interest to the driver.

In some embodiments, for each system, the controller may be further operable to associate a time of imaging the road sign with the road sign interpretation. Additionally, for some such embodiments, the server, for each system, may be further operable to receive the time of imaging the road sign associated with the road sign interpretation.

In some embodiments, the server may be further operable to determine a total number of times the road sign has been imaged on separate occasions by a single system. Additionally or alternatively, the server may be further operable to determine a total number of times the road sign has been imaged on separate occasions by the plurality of systems.

In some embodiments, each system further comprises a display. The display may be communicatively connected to the controller. Additionally, the display may be operable to receive and display a graphic representation. In some such embodiments, the controller is further operable to provide the graphic representation based, at least in part, on the road sign interpretation

These and other aspects, objects, and features of the present disclosure will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF FIGURES

In the drawings:

FIG. 1: A schematic representation of a driving aid system.

FIG. 2: A perspective representation of a vehicle equipped with a driving aid system navigating a roadway.

FIG. 3: A representation of a rearview assembly having a display of a driving aid system.

### DETAILED DESCRIPTION

The specific devices and processes illustrated in the attached drawings and described in this disclosure are simply exemplary embodiments of the inventive concepts defined in the appended claims. Hence, specific characteristics relating the embodiments disclosed herein are not limiting, unless the claims expressly state otherwise.

Some embodiments of the present disclosure are directed to improved driving aid systems. These driving aid systems may have mechanisms for helping a driver gather information from road signs by analyzing the road signs and being operable to provide for visual and/or auditory information related to the analyzed road signs. Accordingly, some embodiments may address the problems associated with reading road signs.

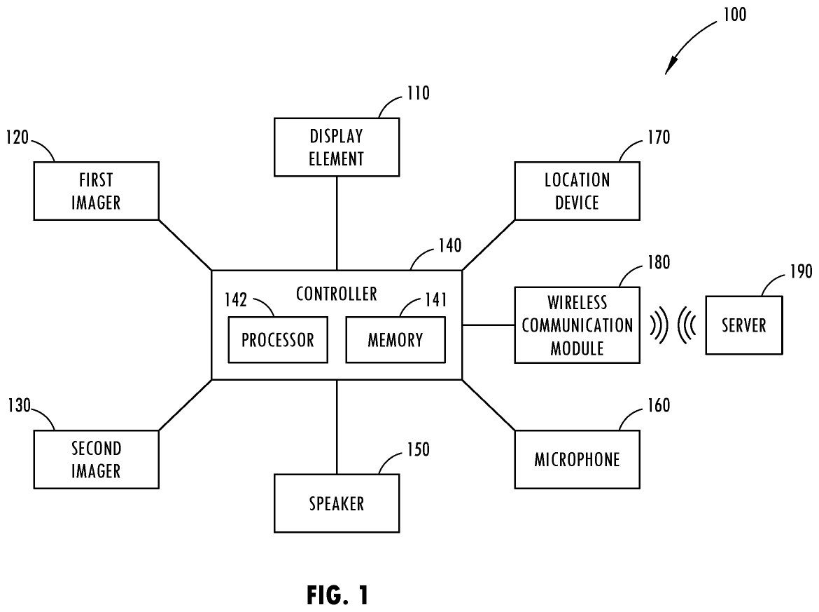

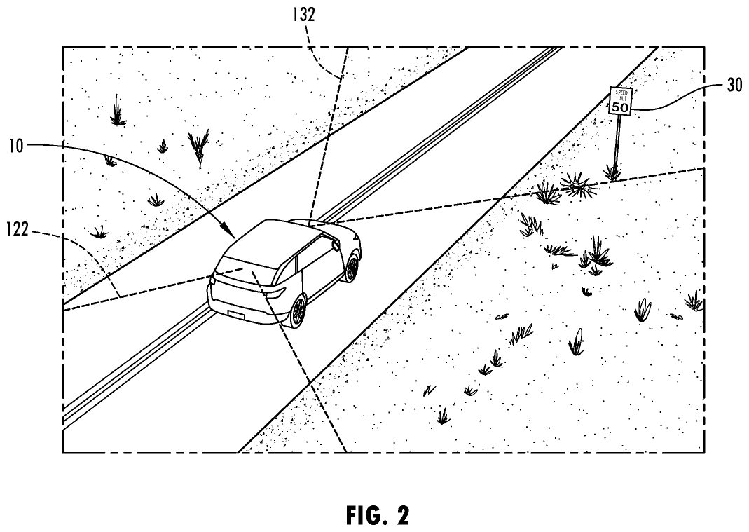

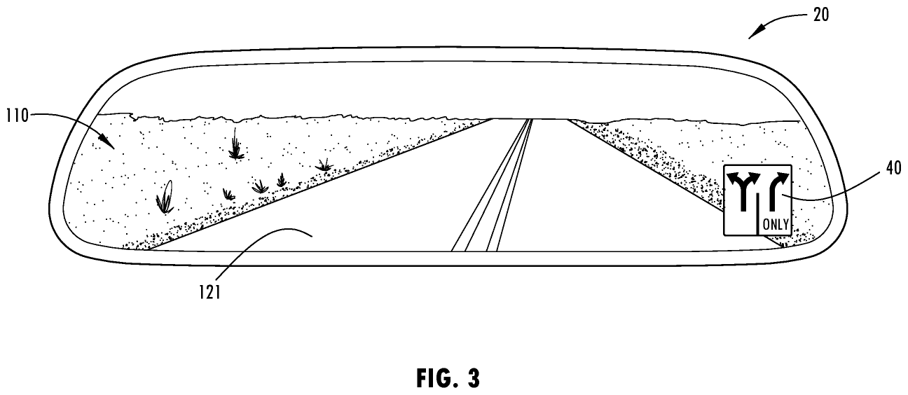

In FIGS. 1-3, aspects of a driving aid system 100 are shown. FIG. 1 is a schematic representation of driving aid system 100. Driving system 100 may comprise a display element 110, a first imager 120, a second imager 130, a controller 140, a speaker 150, a microphone 160, a location device 170, a wireless communication module 180, and/or a server 190. In some embodiments, one or more element of driving aid system 100 may be incorporated into a vehicle 10.

Display element 110 is operable to receive and display one or more images. In some embodiments, an image may be of a scene rearward the vehicle. In other embodiments, an image may be a graphic. Display element 110 may be LCD, LED, OLED, plasma, DLP, or other technology. In some embodiments, display element 110 may be incorporated into a rearview assembly 20. Rearview assembly 20 may be disposed in vehicle 10. In some embodiments, more than one image may be displayed simultaneously. For example, a rearward scene may be displayed with a graphic overlay. The graphic overlay, may, accordingly, partially occlude the image of the rearward scene. In some embodiments, the graphic may be substantially positioned toward a corner of display element 110.

First imager 120 may be a device operable to capture image data. For example, first imager 120 may be a camera. Accordingly, first imager 120 may capture one or more first image 121 and have a first field of view 122. In some embodiments, first imager 120 may be disposed on vehicle 10 and/or positioned and oriented such that first field of view 122 corresponds to a scene rearward vehicle 10. For example, first imager 120 may be located on the vehicle's 10 headliner, rear window, rear bumper, or trunk lid.

Second imager 130 may likewise be a device operable to capture image data. Therefore, second imager 130 may also be a camera. Accordingly, second imager 130 may capture one or more second image and have a second field of view 132. In some embodiments, second imager 130 may be disposed on vehicle 10 and/or positioned and orientated such that second field of view 132 corresponds to a scene forward vehicle 10. In some embodiments, second imager 130 may be a part of rearview assembly 20 and look through a windshield of vehicle 10.

Controller 140 is communicatively connected to display element 110. As used herein, “communicatively connected” may mean connected directly or indirectly though one or more electrical components. Further, controller 140 is operable to communicate images to display element 110. In some embodiments, controller 140 may additionally be communicatively connected to first imager 120. Accordingly, controller 140 may receive first image 121 from first imager 120. Likewise, in some embodiments, controller 140 may be communicatively connected to second imager 130. Accordingly, controller 140 may receive the second image from second imager 130. In some embodiments, controller 140 may be operable to associate a time of imaging with the second image. Controller 140 may comprise a memory 141 and a processor 142. Memory 141 may be operable to store one or more algorithms and processor 142 may be operable to execute the one or more algorithms. In some embodiments, controller 140 may be disposed in rearview assembly 20.

In some embodiments, an algorithm stored by memory 141 may be a road sign detection algorithm. The road sign detection algorithm may be operable to analyze the second image and detect the presence of one or more road sign 30. Road sign 30, for example, may be a traffic sign such as an expressway exit sign, a road name sign, a parking sign, a no parking sign, a mile marker sign, or a speed limit sign. In some embodiments, road sign 30 may even be a roadside advertisement. In other embodiments, road sign 30 may exclude advertisements, such as billboards, and be limited to traffic signs. Upon detection of a road sign 30, the road sign detection algorithm may be further operable to interpret road sign 30. Additionally, the time of imaging the second image may be associated with the interpretation. In some such embodiments, the road sign detection algorithm may be further operable to provide a graphic representation 40 of road sign 30 based, at least in part, on the road sign interpretation. In some embodiments, graphic representation 40 may be provided by generation of new graphic representation 40 to reflect the road sign interpretation, selection of a graphic representation 40 from a plurality of graphic representations 40 stored in memory 141, or modification of a graphic representation. 40 stored in memory 141. Graphic representation 40 may be substantially the same as the road sign 30 or may be a simplified representation of road sign 30. Additionally, graphic representation 40 may be subsequently communicated to display 110 as a third image.

In some embodiments, an algorithm stored by memory 141 may be a duplication prevention algorithm. The duplication prevention algorithm may be operable to analyze a plurality of second images to recognize and delete and/or combine duplicate images and/or interpretations of a road sign 30 from a single occurrence. The duplication prevention algorithm may recognize duplicate images and/or interpretations of a road sign 30 by comparing the second images for substantial similarity, location, and/or time. For example, when passing by a road sign 30, second imager 130 may image road sign 30 more than once during a single pass. However, duplication prevention algorithm may reduce this to a single recorded and/or responded to occurrence.

In some embodiments, an algorithm stored by memory 141 may be a selection algorithm. The selection algorithm may be operable to learn and/or determine what road signs 30 are likely important to, relevant to, or of interest to a driver. In some embodiments, the selection algorithm may have a form of artificial intelligence. The determination, for example, may be based, at least in part, on past behavior, current vehicle condition, or driving situation. In such embodiments, the graphic representation 40 of road sign 30 may be selectively provided and communicated to display 110 as a third image based, at least in part, a determination by the selection algorithm that road sign 30 may be likely important to, relevant to, or of interest to the driver. Accordingly, the graphic representation 40 may be provided and communicated to display 110 as a third image if the road sign 30 may be likely important to, relevant to, or of interest to the driver and not provided and/or communicated to display 110 if the road sign 30 is not determined to be likely important to, relevant to, or of interest to the driver.

For example, the selection algorithm may be able to learn and/or determine that a road sign 30 is likely important to, relevant to, or of interest to a driver based, at least in part, on past behavior of the driver reflected in action taken by the driver substantially proximate in time to imaging a road sign 30 or other road signs 30 having similar interpretations. Accordingly, in further illustration of a situation of the example, if the driver, in the past, has changed vehicle speed or turned after passing or proximate to a particular road sign 30, the selection algorithm may determine that road sign 30 is likely important to, relevant to, or of interest to a driver. In another example, the selection algorithm may be operable to determine and/or learn that a road sign 30 is likely important to, relevant to, or of interest to a driver based on a current vehicle condition, such as vehicle speed. In further illustration of a situation of the example, if the vehicle 10 is operating at a speed greater than a speed limit associated with road sign 30 interpretation, the selection algorithm may determine that the road sign 30 is likely important to, relevant to, or of interest to a driver.

Speaker 150 may be a device operable to emit audible sounds. In some embodiments, speaker 150 may be disposed in vehicle 10 such that a driver may hear the audible sounds. Further, speaker 150 may be communicatively connected to controller 140. Accordingly, in some embodiments, the audible sound may, for example, correspond to an interpretation of a road sign 30, a speed limit, and/or a navigation direction.

In embodiments where controller 140 is communicatively connected to speaker 150, an algorithm stored by memory 141 may be a vocalization algorithm. The vocalization algorithm may be operable to provide audible sounds, such as, verbal communications, for communicating with the driver. In some embodiments, the vocalization algorithm may be operable to provide a verbal communication based, at least in part, on an interpretation of a road sign 30. These audible sounds may be emitted by speaker 150. In some embodiments, audible sound may be provided by the vocalization algorithm via generation of new audible sound, selection of an audible sound from a plurality of audible sounds stored in memory 141, or modification of an audible sound stored in memory 141.

In some embodiments, the audible sounds may be selectively provided, communicated to speaker 150, and/or emitted by speaker 150 based on a determination by the selection algorithm that the road sign 30 is likely important to, relevant to, or of interest to the driver. Accordingly, the audible sounds may be selectively provided, communicated to speaker 150, and/or emitted by speaker 150 if the road sign 30 is determined to be likely important to, relevant to, or of interest to the driver and but not if the road sign 30 is not determined to be likely important to, relevant to, or of interest to the driver.

Microphone 160 may be any device operable to receive sounds and/or record sound. In some embodiments, microphone 160 may be disposed in vehicle 10 such that verbal commands and/or questions from the driver may be received. Accordingly, the sound may be the voice of the driver. In some such embodiments, microphone 160 may be a part of rearview assembly 20. Microphone 160 may be communicatively connected to controller 140. Accordingly, controller 140 may receive the verbal commands and/or questions of the sound.

In embodiments where controller 140 may receive a communication corresponding to the sound, an algorithm stored by memory 141 may be a sound recognition algorithm. The sound recognition algorithm may be operable to analyze the sound communication and interpret a meaning of a verbal command and/or question contained in the sound. Based, at least in part, on the interpretation of the sound, controller 140 may be operable to provide an auditory or a visual response.

In yet another example, related to the selection algorithm, the selection algorithm may be able to determine or learn that a road sign 30 is likely important to, relevant to, or of interest to a driver based, at least in part, on past behavior, such as, the driver asking questions with increased frequency. These questions may be determined based, at least in part, on interpretations by the sound recognition algorithm. For example, a driver in an unfamiliar area and/or in greater need of assistance than usual, may ask questions with increased frequency, allowing the selection algorithm to determine that a road sign 30 is likely important to, relevant to, or of interest to a driver based on this recent past behavior even though under other conditions where questions are asked with decreased frequency, such a road sign 30 may not have been determined as likely important to, relevant to, or of interest to the driver.

Location device 170 may be any device operable to determine a location of vehicle 10. Location device 170 may be a global positioning system (GPS) unit or cellular triangulation unit. Additionally, location device 170 may be communicatively connected to controller 140. In some embodiments, location device 170 may be incorporated into vehicle 10 and/or rearview assembly 20. In other embodiments, location device 170 maybe a personal communications device, such as a cell phone. The personal communication device may be communicatively connected to driving aid system 100 by Wi-Fi, Bluetooth, radio, cellular, or other communications technology.

In embodiments where controller 140 is communicatively connected to location device 170, controller 140 may receive the vehicle's 10 location. Further, an algorithm stored by memory 141 may be a location association algorithm. The location association algorithm may be operable to associate a location with a road sign 30. Further, memory 141 may be further operable to store an interpretation of road sign 30 along with the associated location.

In yet another example, related to the selection algorithm, the selection algorithm may be operable to determine a road sign 30 is likely important to, relevant to, or of interest to a driver based on driving situation such as the vehicle's 10 location. Further, the driving situation may further comprise additional information such as the vehicle's 10 destination, which may be retrieved from a source such as a navigation system. For example, the selection algorithm may be operable to determine that a road sign 30 with an interpretation related to vehicle parking is likely important to, relevant to, or of interest to a driver when the vehicle's location 10 is proximate the vehicle's 10 destination. This may, for example, allow the selection algorithm to determine that a road sign 30 is likely important to, relevant to, or of interest to the driver based on the location and/or destination of the vehicle 10, even though under other conditions, such as where the destination of substantial distance from the vehicle's 10 location, such a road sign 30 may not have been determined as likely important to, relevant to, or of interest to the driver.

Wireless communication module 180 may be a device operable to facilitate communication between controller 140 and one or more of display element 110, first imager 120, second imager 130, speaker 150, microphone 160, location device 170, and/or server 190. Accordingly, wireless communication module 180 may be disposed in vehicle 10. Wireless communication module 180 may utilize Wi-Fi, Bluetooth, radio, cellular, satellite, or other communications technology.

Server 190 may be remotely disposed relative vehicle 10. Accordingly, server 190 may be communicatively connected to controller 140 via wireless communication module 180. In some embodiments, server 190 may be communicatively connected to a plurality of controllers 14 of a plurality of driving aid systems 100. Server 190 may be operable to receive road sign interpretations, location data associated with each road sign 30 image and/or interpretation, times associated with each road sign 30 image and/or interpretation was imaged, received sounds, and/or interpretations of the received sounds. In some embodiments, server 190 may be operable to communicate algorithm updates to controller 140. Additionally, server 190 may be communicatively connected to a plurality of controllers 140 of a plurality of driving aid systems 100. Therefore, based, at least in part, on a location, a time, and/or an interpretation of a road sign 30, server 190 may be operable to determine a total number of occurrences a particular road sign 30 has been viewed by one or more driving aid system 100 and/or one or more driver. In some embodiments, the number of occurrences may be determined based, at least in part, on time for an individual driving aid system 100 to prevent counting an occurrence as multiple occurrences due to multiple images during one occurrence. Further, server 190 may be operable to determine a total number of times a question is asked in regard to a particular road sign 30 by one or more drivers.

In operation, vehicle 10 may drive down a road. While driving down the road, first imager 110 may capture first image 121 and/or second imager 130 may capture the second image. Controller 140 may analyze the second image to detect the presence of a road sign 30. Further, controller 140 may interpret road sign 30 and provide a corresponding graphic representation 40 of road sign 30. The first image 121 may be displayed by display element 110 to provide the driver with a field of view rearward relative vehicle 10. Further, display element 110 may likewise display graphic representation 40. In some embodiments, graphic representation 40 may be overlaid onto first image 121. In other embodiments, the graphic representation may be displayed beside first image 121.

In some embodiments, driving aid system 100 may further be operable to respond to a command and/or question from the driver. The driver may verbally provide a command and/or question as a sound. The sound may be received by microphone 160 and communicated to controller 140. Controller 140 may then interpret a meaning of the sound. Based, at least in part, on the interpretation of the sound, controller 140 may be operable to provide an auditory and/or visual response.

In embodiments where the response is auditory, controller 140 may be operable to determine a proper response to the command and/or question based, at least in part, on a relevant road sign interpretation, and provide a verbal interpretation of the response. The verbal response may be broadcast to the driver by speaker 150. In one embodiment, the driver may ask what the speed limit is and driving aid system 100 may answer with the speed limit of a relevant road sign 30. For example, the driver may ask: “what is the speed limit here?” and driving aid system 100 may respond with: “the speed limit is 45 MPH.” In another embodiment, the driver may ask what the last sign said and the driving aid system 100 may answer by interpreting the last road sign 30, such as a speed limit sign or a construction sign. For example, the driver may ask: “what did that sign say?” and driving aid system 100 may respond by reading an interpretation of the relevant road sign 30, such as, “construction ahead” of “exit 43, Main Street, closed.” In yet another embodiment, the driver may ask if a particular exit has been passed and driving aid system 100 may answer based, at least in part, on an interpretation of one or more relevant road signs 30, such as exit signs. For example, the driver may ask: “did we pass the exit 56 yet?” and driving aid system 100 may respond with: “no, the last exit was exit 52.” In yet another embodiment, the driver may ask what road he/she is on and driving aid system 100 may answer based, at least in part, on the interpretation of a relevant road sign 30, such as a street sign. For example, the driver may ask: “what road is this?” and driving aid system 100 may respond with: “this is Main Avenue.” In yet another embodiment, the driver may ask about information listed on an exit sign such as restaurants, gas stations, and/or attractions, and driving aid system 100 may respond with an interpretation of a relevant road sign 30, such as an exit sign. For example, the driver may ask: “what restaurants are at this exit?” and driving aid system 100 may respond: “there were two restaurants on the sign for the next exit: Subway and McDonalds.” In yet another embodiment, the driver may ask about mile marker road signs 30 and driving aid system 100 may respond based, at least in part, on an interpretation of a relevant road sign 30, such as a mile marker. For example, the driver may ask: “what was the last mile marker?” and driving aid system 100 may respond: “you last passed mile marker 355.”

In some embodiments, in addition to determining a proper response to the command and/or question based, at least in part, on the relevant road sign interpretation, controller 140 may further base the proper response, at least in part, on information from location device 170. In some embodiments, driving aid system 100 may further provide additional information such as how far back down the road sign 30 was imaged. For example, driving aid system 100 may respond: “there was a 45 MPH speed limit sign half a mile back.” In other embodiments, driving aid system 100 may select the relevant road sign interpretation from a distant time with an association of a proximate location, such as a previous trip.

In other embodiments, controller 140 may determine a proper response to the command and/or question that communicates an absence of a relevant road sign 30. For example, the driver may ask: “can I park here?” and the driving aid system 100 may respond: “I have not seen any no-parking signs during this drive.”

In embodiments where the response is visual, controller 140 may be operable to determine a relevant road sign interpretation as a response to the verbal command and/or question and provide a graphic representation 40 of road sign 30. Graphic representation 40 may be displayed via display element 110, providing the visual response to the driver. In one embodiment, the driver may ask what the speed limit is and display element 110 may display a graphic representation 40, such as a speed limit sign, with the appropriate speed limit. In another embodiment, the driver may ask what the last sign said and display element 110 may display a graphic representation 40 of the last road sign 30. In yet another embodiment, the driver may ask what road he/she is on and display element 110 may display a graphic representation 40 of the relevant road sign 30, such as a street sign. In yet another embodiment, the driver may ask about information listed on an exit sign such as what restaurants, gas stations, and/or attractions are at the next exit, and display element 110 may display the relevant information on a graphic representation 40 of the relevant road sign 30, such as an exit sign. In yet another embodiment, the driver may ask what was the last mile marker and display element 110 may display a graphic representation 40 of a relevant road sign 30, such as a mile marker. In yet another embodiment, the driver may command driving aid system 100 to show the turn lanes and display element 110 may display the relevant road sign 30, such as a turn lane sign.

In the foregoing embodiments and examples, to provide the auditory and/or visual response, driving aid system 100 may have relied, at least in part, on determining the relevant road sign interpretation. Driving aid system 100 may make such a determination in a variety of manners. In some embodiments, controller 140 may organize the road sign interpretations into categories to aid in selection of the relevant road sign interpretation. For example, the road sign interpretations may be organized into categories. Some categories may be for types of road signs 30, such as, mile markers, speed limit signs, turn lane signs, advertisements, expressway exit signs, street name signs, and/or parking signs. Other categories may be based, at least in part, on the circumstances surrounding the imaging of the road sign 30, such as, time of imaging and/or location of imaging. In some further embodiments, by interpreting the received sound, controller 140 may determine a relevant category from which to select a road sign interpretation for response. Additionally, a road sign interpretation from within the category may be selected by controller 140 as being the most recent and/or within a certain distance and therefore most relevant.

Embodiments of driving aid system 100 may have the advantage of enabling a driver to access information from one or more road sign 30 on request. Accordingly, the driver may have access to road signs 30 they did not see or have trouble remembering. This is particularly advantageous when driving faster, navigating heavy traffic, or there are obstructions to the driver's field of view. Additionally, some embodiments may have the advantage of providing information to a centralized server such that information as to the number of times a road sign 30 is viewed or the number of times a driver asks about a certain road sign 30 may be obtained. Such information may be advantageous for determining how many views an advertisement may receive or determining how problematic road sign 30 placement may be for viewing by a driver.

In this document, relational terms, such as “first,” “second,” and the like, are used solely to distinguish one entity or action from another entity or action, without necessarily requiring or implying any actual such relationship or order between such entities or actions.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. A system comprising:
a first imager operable to capture a first image, the first imager having a field of view forward relative a vehicle;
a controller communicatively connected to the first imager, the controller operable to:
detect a road sign in the first image,
interpret the road sign, and
provide a graphic representation based, at least in part, on the road sign; and
a rearview assembly communicatively connected to the controller, the rearview assembly operable to receive and display the graphic representation.

2. The system of claim 1, further comprising:
a second imager operable to capture a second image, the second imager having a field of view rearward relative the vehicle;
wherein the rearview assembly is operable to display the second image.

3. The system of claim 1, further comprising:
a microphone communicatively connected to the controller and disposed interior the vehicle, the microphone operable to capture a driver's voice;
wherein the controller is further operable to:
interpret the driver's voice to identify at least one of a command and question, and
communicate the graphic representation to the rearview assembly based, at least in part, on the at least one of the command and question.

4. The system of claim 1, further comprising:
a speaker disposed interior the vehicle and communicatively connected to the controller, the speaker operable to emit an auditory response;
wherein the controller is further operable to:
provide the auditory response based, at least in part, on the interpretation of the road sign, and
communicate the auditory response to the speaker.

5. The system of claim 4, further comprising:
a microphone communicatively connected to the controller and disposed interior the vehicle, the microphone operable to capture a driver's voice;
wherein the controller is further operable to:
interpret the driver's voice to identify at least one of a command and question,
provide the auditory response based, at least in part, on the interpretation of the driver's voice, and
communicate the auditory response to the speaker.

6. The system of claim 2, wherein the graphic representation is overlaid onto the second image.

7. The system of claim 1, further comprising:
a location device operable to determine a location of the vehicle, the location device communicatively connected to the controller;
wherein the controller is further operable to associate the location at the time of capturing the first image with the road sign interpretation.

8. The system of claim 1, wherein the controller is further operable to:
determine whether the road sign is likely of interest to a driver, and
selectively at least one of provide the graphic representation and display the graphic representation based, at least in part, on a determination that the road sign is likely of interest to the driver.

9. A system comprising:
a first imager operable to capture a first image, the first imager having a field of view forward relative a vehicle;
a controller communicatively connected to the first imager, the controller operable to:
detect a road sign in the first image,
interpret the road sign, and
provide an auditory response based, at least in part, on the road sign; and
a speaker disposed interior the vehicle and communicatively connected to the controller, the speaker operable to emit the auditory response.

10. The system of claim 9, further comprising:
a microphone communicatively connected to the controller and disposed interior the vehicle, the microphone operable to capture a driver's voice;
wherein the controller is further operable to:
interpret the driver's voice to identify at least one of a command and question,
provide the auditory response based, at least in part, on the interpretation of the driver's voice, and
communicate the auditory response to the speaker.

11. The system of claim 9, further comprising:
a display element communicatively connected to the controller, the display element operable to receive and display a graphic representation;
wherein the controller is further operable to provide the graphic representation based, at least in part, on the road sign.

12. The system of claim 9, wherein the controller is further operable to:
determine whether the road sign is likely of interest to a driver, and
selectively at least one of provide the auditory response and emit the auditory response based, at least in part, on a determination that the road sign is likely of interest to the driver.

13. The system of claim 11, further comprising:
a second imager operable to capture a second image, the second imager having a field of view rearward relative the vehicle;
wherein the display element is further operable to display the second image.

14. The system of claim 9, further comprising:
a location device operable to determine a location of the vehicle, the location device communicatively connected to the controller;
wherein the controller is further operable to associate the location at the time of capturing the first image with the road sign interpretation.

15. A network comprising:
a plurality of systems, each system comprising:
an imager operable to capture a plurality of images, the imager having a field of view forward relative a vehicle;
a location device operable to determine a location of the vehicle;
a controller communicatively connected to the imager and the location device, the controller, for each image of the plurality of images, operable to:
detect a road sign in an image,
interpret the road sign, and
associate the location at the time of imaging the road sign with the road sign interpretation; and
a server, the server relative each system:
located remote relative the vehicle,
communicatively connected to the controller, and
operable to receive one or more road sign interpretations and associated locations.

16. The network of claim 15, wherein, for each system:
the controller is further operable to associate a time of imaging the road sign with the road sign interpretation; and
the server, for each system, is further operable to receive the time of imaging the road sign associated with the road sign interpretation.

17. The network of claim 15, wherein the server is further operable to determine a total number of times the road sign has been imaged on separate occasions by a single system.

18. The network of claim 15, wherein the server is further operable to determine a total number of times the road sign has been imaged on separate occasions by the plurality of systems.

19. The network of claim 15, wherein each system further comprises:
a display, communicatively connected to the controller, the display operable to receive and display a graphic representation;
wherein the controller is further operable to provide the graphic representation based, at least in part, on the road sign interpretation.

20. The system of claim 19, wherein the controller is further operable to:
determine whether the road sign is likely of interest to a driver, and
selectively at least one of provide the graphic representation and display the graphic representation based, at least in part, on a determination that the road sign is likely of interest to the driver.
